(19) United States
(12) Patent Application Publication
(10) Pub. No.: US 2024/0283612 A1
(43) Pub. Date: Aug. 22, 2024

(54) WAVEFORM DETERMINATION FOR UPLINK TRANSMISSIONS

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/430,399

(22) Filed: Feb. 1, 2024

Related U.S. Application Data
(60) Provisional application No. 63/446,245, filed on Feb. 16, 2023.
(60) Provisional application No. 63/447,794, filed on Feb. 23, 2023.
(60) Provisional application No. 63/455,853, filed on Mar. 30, 2023.
(60) Provisional application No. 63/458,020, filed on Apr. 7, 2023.
(60) Provisional application No. 63/544,121, filed on Oct. 13, 2023.

(51) Int. Cl. H04L 5/00; H04L 27/26; H04W 72/0453

(52) U.S. Cl. CPC H04L 5/0053; H04L 27/26; H04W 72/0453

(57) ABSTRACT

Apparatuses and methods for waveform determination for uplink (UL) transmissions. A method includes receiving first information indicating whether transform precoding is enabled or disabled, second information indicating a presence of a transform precoder indication (TPI) field in a downlink control information (DCI) format, third information for a configuration related to a resource allocation associated with transmissions of physical uplink shared channels (PUSCHs) with transform precoding disabled, and a channel providing the DCI format that schedules a transmission of a PUSCH. The method further includes determining whether the transform precoding is enabled based on the TPI field, that the configuration is used when transform precoding is disabled, and that the configuration is not used when transform precoding is enabled. The method further includes transmitting the PUSCH with transform precoding and without the configuration, when transform precoding is enabled, or without transform precoding and with the configuration, when transform precoding is disabled.

### CROSS-REFERENCE TO RELATED AND CLAIM OF PRIORITY

The present application claims priority under 35 U.S.C. § 119(e) to: U.S. Provisional Patent Application No. 63/446,245 filed on Feb. 16, 2023; U.S. Provisional Patent Application No. 63/447,794 filed on Feb. 23, 2023; U.S. Provisional Patent Application No. 63/455,853 filed on Mar. 30, 2023; U.S. Provisional Patent Application No. 63/458,020 filed on Apr. 7, 2023; and U.S. Provisional Patent Application No. 63/544,121 filed on Oct. 13, 2023, which are hereby incorporated by reference in their entirety.

### TECHNICAL FIELD

The present disclosure relates generally to wireless communication systems and, more specifically, the present disclosure is related to apparatuses and methods for waveform determination for uplink (UL) transmissions.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to waveform determination for UL transmissions.

In one embodiment, a user equipment (UE) is provided. The UE includes a transceiver configured to receive first information by higher layers indicating whether transform precoding is enabled or disabled, second information by higher layers indicating a presence of a transform precoder indication (TPI) field in a downlink control information (DCI) format, third information by higher layers for a configuration related to a resource allocation associated with transmissions of physical uplink shared channels (PUSCHs) with transform precoding disabled, and a physical downlink control channel (PDCCH) providing the DCI format that schedules a transmission of a PUSCH. When the second information indicates that the TPI field is present, the DCI format includes the TPI field. The UE further includes a processor operably coupled to the transceiver. The processor is configured to determine whether the transform precoding is enabled or disabled based on the TPI field, that the configuration is used when transform precoding is disabled, and that the configuration is not used when transform precoding is enabled. The transceiver is further configured to transmit the PUSCH with transform precoding and without the configuration, when transform precoding is enabled, or without transform precoding and with the configuration, when transform precoding is disabled.

In another embodiment, a base station (BS) is provided. The BS includes a transceiver configured to transmit first information by higher layers indicating whether transform precoding is enabled or disabled, second information by higher layers indicating a presence of a TPI field in a DCI format, third information by higher layers for a configuration related to a resource allocation associated with receptions of PUSCHs with transform precoding disabled, and a PDCCH providing the DCI format that schedules a reception of a PUSCH. When the second information indicates that the TPI field is present, the DCI format includes the TPI field. The UE further includes a processor operably coupled to the transceiver. The processor is configured to determine whether the transform precoding is enabled or disabled based on the TPI field, that the configuration is used when transform precoding is disabled, and that the configuration is not used when transform precoding is enabled. The transceiver is further configured to receive the PUSCH with transform precoding and without the configuration, when transform precoding is enabled, or without transform precoding and with the configuration, when transform precoding is disabled.

In yet another embodiment, a method is provided. The method includes receiving first information by higher layers indicating whether transform precoding is enabled or disabled, second information by higher layers indicating a presence of a TPI field in a DCI format, third information by higher layers for a configuration related to a resource allocation associated with transmissions of PUSCHs with transform precoding disabled, and a PDCCH providing the DCI format that schedules a transmission of a PUSCH. When the second information indicates that the TPI field is present the DCI format includes the TPI field. The method further includes determining whether the transform precoding is enabled or disabled based on the TPI field, that the configuration is used when transform precoding is disabled, and that the configuration is not used when transform precoding is enabled. The method further includes transmitting the PUSCH with transform precoding and without the configuration, when transform precoding is enabled, or without transform precoding and with the configuration, when transform precoding is disabled.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a flowchart of an example UE procedure for determining a waveform for a physical uplink shared channel (PUSCH) transmission according to embodiments of the present disclosure;

FIG. 7 illustrates diagrams of example cyclic prefix (CP)-orthogonal frequency division multiplexing (OFDM) configurations according to embodiments of the present disclosure;

FIG. 8 illustrates diagrams of example CP-OFDM configurations according to embodiments of the present disclosure;

FIG. 9 illustrates a flowchart of an example UE procedure for determining information according to embodiments of the present disclosure;

FIG. 10 illustrates a flowchart of an example UE procedure for determining information according to embodiments of the present disclosure;

FIG. 11 illustrates a flowchart of an example UE procedure for determining information according to embodiments of the present disclosure;

FIG. 12 illustrates a flowchart of an example UE procedure for considering a transform precoding according to embodiments of the present disclosure; and

FIG. 13 illustrates a flowchart of an example UE procedure for determining a modulation order and a target code rate according to embodiments of the present disclosure.

### DETAILED DESCRIPTION

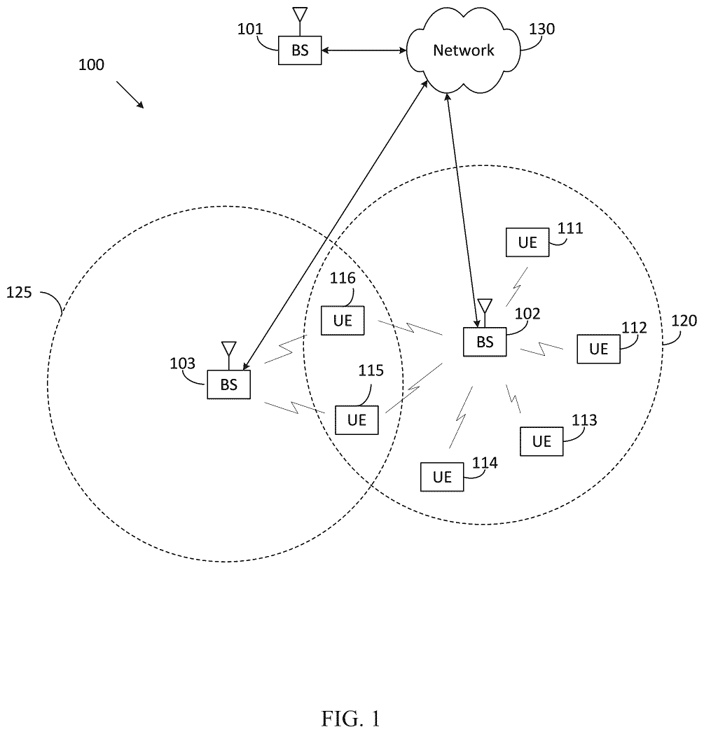

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and channel coding;” [3] 3GPP TS 38.213 v17.4.0, “NR; Physical layer procedures for control;” [4] 3GPP TS 38.214 v17.4.0, “NR; Physical layer procedures for data;” [5] 3GPP TS 38.215 v17.4.0, “NR; Physical layer measurements;” [6] 3GPP TS 38.321 v17.3.0, “NR; Medium Access Control (MAC) protocol specification;” [7] 3GPP TS 38.331 v17.2.0, “NR; Radio Resource Control (RRC) protocol specification;” and [8] 3GPP TS 38.300 v17.3.0, “NR; NR and NG-RAN Overall Description; Stage 2.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing waveform determination for UL transmissions. In certain embodiments, one or more of the BSs 101-103 include circuitry, programing, or a combination thereof to support and enable waveform determination for UL transmissions.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

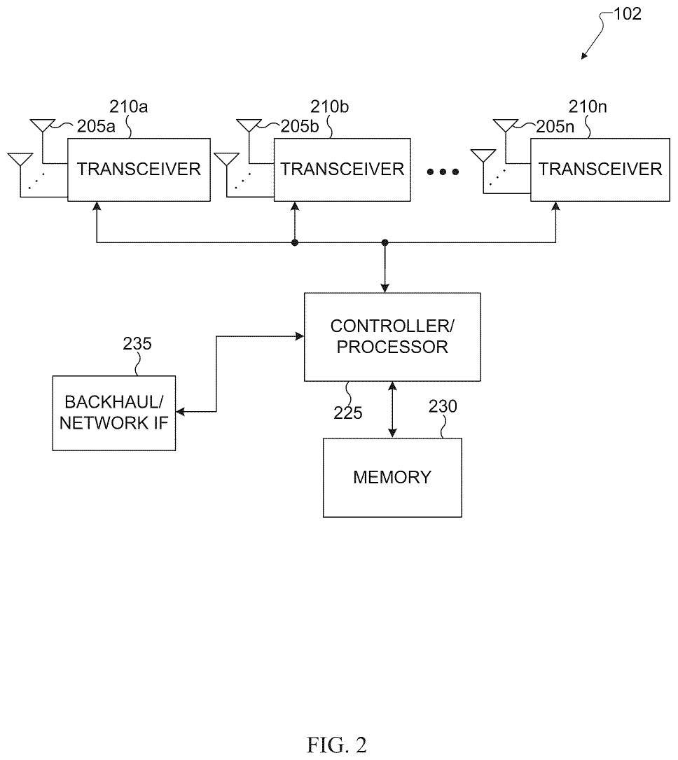

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods to enable and support waveform determination for UL transmissions. Any of a wide variety of other functions could be supported in the gNB 102 by the controller/processor 225.

The controller/processor 225 is also capable of executing programs and other processes resident in the memory 230, such as processes to enable and support waveform determination for UL transmissions. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

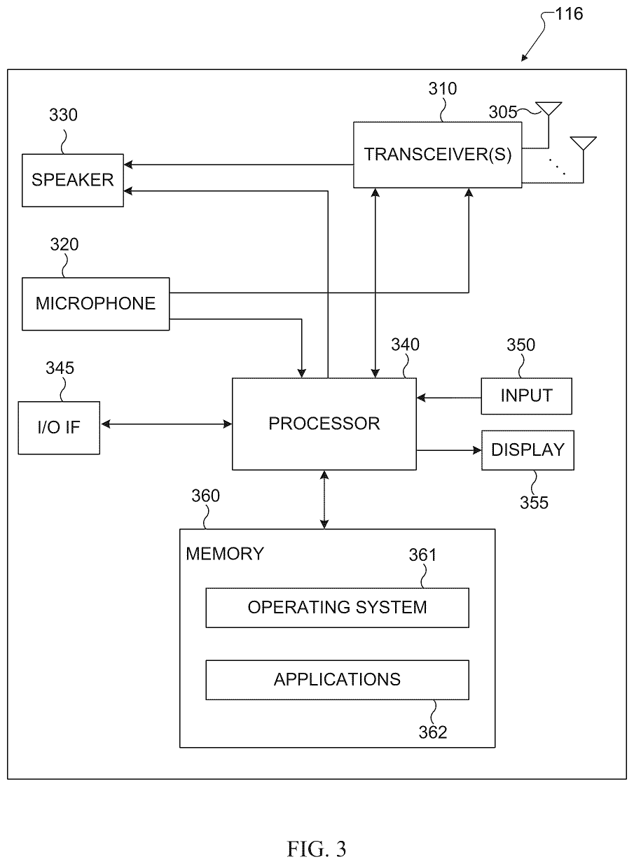

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing waveform determinations for UL transmissions as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

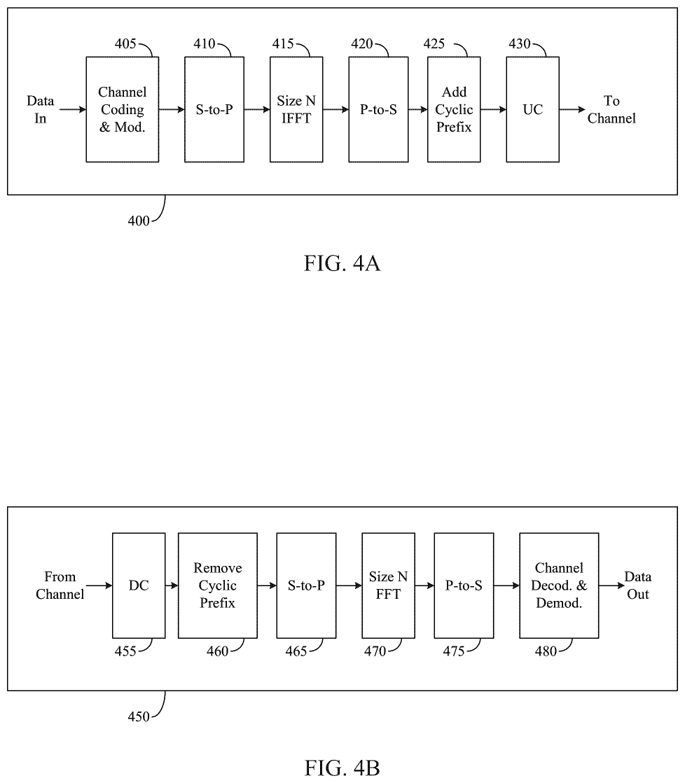

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to utilize waveform determinations for UL transmissions as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Embodiments of the present disclosure also apply when a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding RS (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

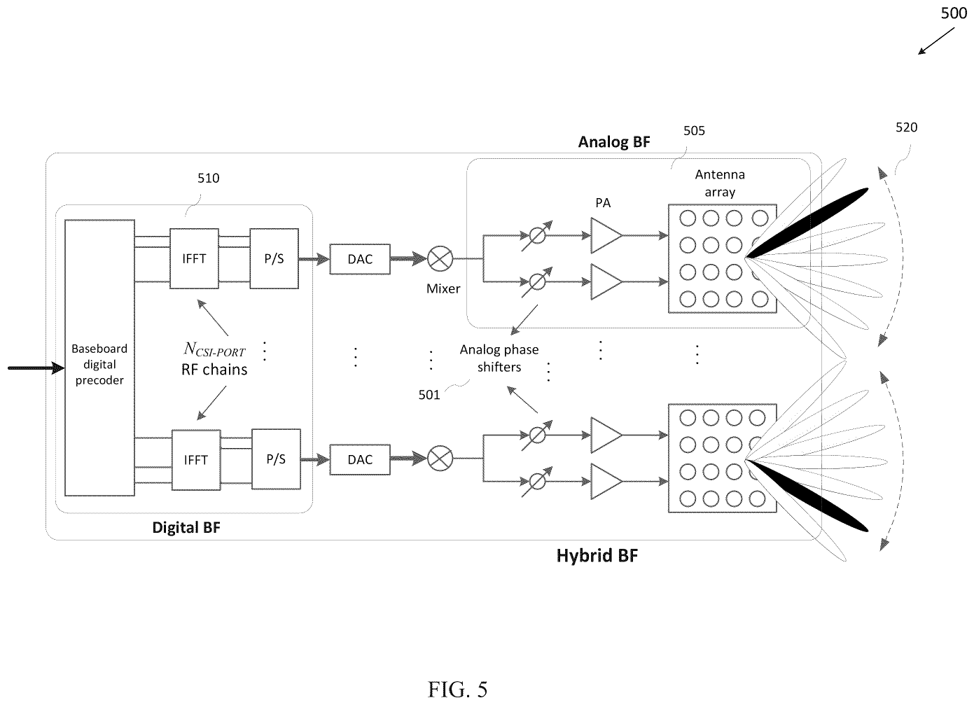

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

A description of example embodiments is provided on the follow pages. A parameter referenced in italics is provided by higher layers.

The embodiments apply to any deployments, verticals, or scenarios including PRACH transmissions in FR1 or FR2, for enhanced mobile broadband (eMBB), ultra reliable low latency communications (URLLC), industrial internet of things (IIoT), extended reality (XR), massive machine-type communications (mMTC) and internet of things (IoT) including LTE narrowband (NB)-IoT or NR IoT or Ambient IoT (A-IoT), with sidelink/vehicle-to-everything (V2X) communications, with multi-TRP/beam/panel, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, and so on.

UL signals include data signals conveying information content, control signals conveying UL control information (UCI), DM-RS associated with data or UCI demodulation, phase-tracking RS (PT-RS) used for phase tracking in symbols of a PUSCH, and sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of symbols in a slot including one symbol. When a UE simultaneously transmits data information and UCI, the UE 116 can multiplex both in a PUSCH or, depending on a UE capability, transmit both a PUSCH with data information and a PUCCH with UCI at least when the transmissions are on different cells.

UL RS includes DM-RS, PT-RS, and SRS. DM-RS is typically transmitted within a bandwidth (BW) of a respective PUSCH or PUCCH. A gNB can use a DM-RS to demodulate information in a respective PUSCH or PUCCH. SRS is transmitted by a UE to provide a gNB with an UL CSI and, for a time division duplexing (TDD) system, to also provide a precoding matrix indicator (PMI) for DL transmission. Further, as part of a random access procedure or for other purposes, a UE can transmit a physical random access channel (PRACH).

UCI includes hybrid automatic repeat request acknowledgement (HARQ-ACK) information, indicating correct or incorrect decoding of transport blocks (TBs) or of code block groups (CBGs) in a physical DL shared channel (PDSCH), scheduling request (SR) indicating whether a UE has data in its buffer to transmit, and CSI reports enabling a gNB to select appropriate parameters for PDSCH/TB or physical downlink control channel (PDCCH)/DCI format transmissions to a UE. A UE transmits a PUCCH on a primary cell of a cell group. HARQ-ACK information is either a positive acknowledgement (ACK) when a TB decoding is correct or a negative acknowledgement (NACK) when a TB decoding is incorrect. An ACK can be represented by a binary ‘1’ value and a NACK can be represented by a binary ‘0’ value.

A UE can multiplex uplink control information (UCI) in a PUCCH using different formats. A PUCCH transmission using PUCCH formats 0 and 2 is over at most 2 OFDM symbols, while a PUCCH transmission using PUCCH formats 1, 3, or 4 is over from 4 to 14 symbols. PUCCH formats with longer duration (number of symbols) are used for enhanced coverage. When a number of symbols in a slot are not sufficient for coverage, repetitions of a PUCCH transmission can apply to enhance coverage.

In order to improve a reception reliability, a PUCCH transmission can be repeated over a number of slots, wherein a repetition of the PUCCH transmission in each slot starts from a same symbol in the slot and is over a same number of consecutive symbols. When there are not enough available symbols in a slot for a repetition of the PUCCH transmission, or the repetition cannot start from a configured or indicated first symbol, or the repetition cannot occur in consecutive symbols of a slot, the UE 116 does not transmit the PUCCH repetition in that slot. In such scenarios, either the UCI reception reliability is degraded when the UE 116 does not transmit all configured repetitions of a PUCCH transmission or, when the UE 116 postpones to a next slot a repetition of a PUCCH transmission that the UE 116 cannot transmit in a current slot, the completion of the PUCCH transmission with repetitions requires a longer time, thereby causing a longer latency. Also, an efficiency of UL resource allocation can be affected because some symbols that are available for UL transmission in a slot may not be used for a repetition of the PUCCH transmission due to the aforementioned reasons. It is also possible that there are enough available symbols for more than one repetition of a PUCCH transmission in a slot, but the UE 116 is restricted to transmit only one repetition of a PUCCH transmission per slot.

In order to improve a reception reliability, a UE can transmit a physical uplink data channel (PUSCH) over a number of time units corresponding to a number of repetitions. A PUSCH can be transmitted with Type A or Type B repetitions. For PUSCH repetition Type A, a UE determines a starting symbol S relative to the start of a slot and a number of consecutive symbols L for a repetition of a PUSCH transmission from the start and length indicator value, SLIV, of an indexed row of a time domain resource allocation (TDRA) table. A UE determines a number of repetitions K from the row of the TDRA table or from a higher layer parameter and repeats the PUSCH transmission across the K consecutive slots by applying a same symbol allocation in each slot. In the following, for brevity, an italicized parameter name refers to a higher layer parameter. The UE 116 transmits a repetition of the PUSCH transmission in a slot only when L consecutive symbols in the slot, starting from symbol S, are not downlink (DL) symbols. For PUSCH repetition Type B, the starting symbol S relative to the start of the slot, and the number of consecutive symbols L counting from the symbol S allocated for the PUSCH, are provided by startSymbol and length of the indexed row of the resource allocation table, respectively. The number of nominal repetitions is given by memberofrepetitions.

DFT-S-OFDM waveform is beneficial for UL coverage limited scenario because of its lower peak-to-average power ratio (PAPR) compared with CP-OFDM waveform. A DFT-S-OFDM transmission scheme would likely be used with lower modulation and coding scheme (MCS) values, lower coding rates and lower modulation order, and be used for UEs in coverage limited scenarios operating at low signal-to-noise ratio (SNR). A CP-OFDM transmission scheme would likely be used with higher MCS values and for UEs not in coverage limited situations operating at higher SNRs. The UE 116 can be configured with different MCS tables for CP-OFDM and for DFT-S-OFDM, and also different tables for 64 QAM and 256 QAM. Embodiments of the present disclosure recognize, as a UE experiences different channel conditions within the cell and its operating signal to interference and noise ratio (SINR) changes, it can be beneficial for the gNB 102 to change the transmission scheme of the UE 116 in order to optimize performance and/or to maintain the link. In current specifications, the transmission scheme is configured by the network 130 and a reconfiguration is needed to change between CP-OFDM and DFT-S-OFDM. This is reasonable as a gNB cannot make instantaneous decisions for a UE and a change in waveform/coverage is typically decided based on received signal received power (RSRP) reports or long term block error rate (BLER) statistics (e.g., similar to OLLA). Nevertheless, RRC adds some latency which can be beneficial to avoid especially when switching over to DFT-S-OFDM for cell-edge UEs. Thus, support of DL control information (DCI)-based switching between discrete Fourier transform-spread-orthogonal frequency division multiplexing (DFT-S-OFDM) and CP-OFDM for UL transmissions is considered.

The present disclosure relates to determining a waveform for an uplink transmission. The present disclosure relates to determining the waveform for a PUSCH transmission based on an indication in a DCI format. The present disclosure also relates to UE procedures for transmitting the PUSCH for a dynamic waveform indication. The present disclosure also relates to determining a rank for a PUSCH transmission scheduled by a DCI format that indicates a waveform. The present disclosure also relates to applying transform precoding on PUSCH, determining modulation order and target code rate for a dynamic waveform indication. The present disclosure further relates to determining the waveform for a Msg3 PUSCH transmission. The proposed solutions enhance the UE's capability to manage its UL transmissions, thereby ensuring better connectivity, increased throughput, and improved overall user experience in various coverage and channel conditions.

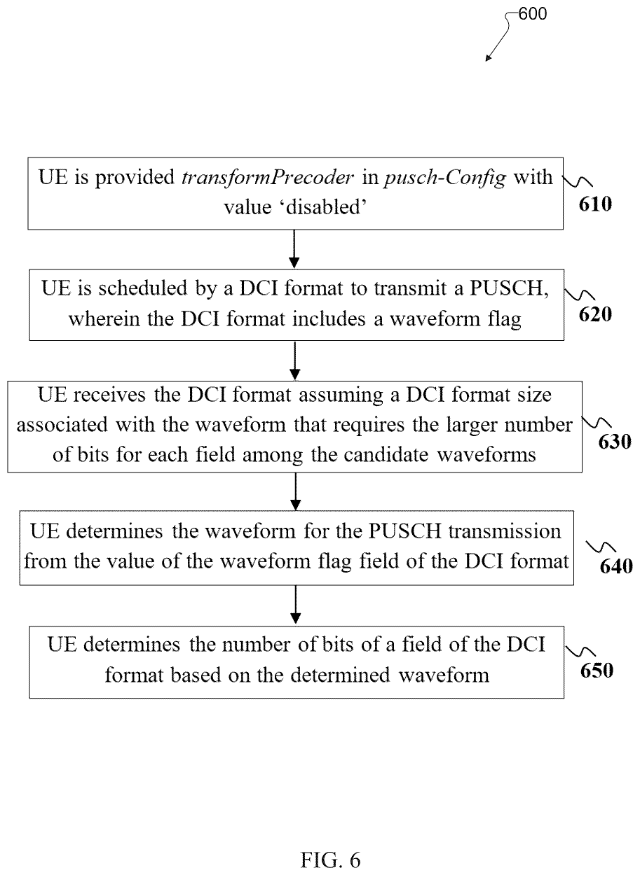

FIG. 6 illustrates a flowchart of an example UE procedure 600 for determining a waveform for a PUSCH transmission according to embodiments of the present disclosure. For example, procedure 600 for determining a waveform for a PUSCH transmission can be performed by any of the UEs 111-116 of FIG. 1. This example is for illustration only and other embodiments can be used without departing from the scope of the present disclosure.

The procedure begins in 610, a UE is provided transformPrecoder in pusch-Config with value ‘disabled’. In 620, the UE 116 is scheduled by a DCI format to transmit a PUSCH, wherein the DCI format includes a waveform flag. In 630, the UE 116 receives the DCI format assuming a DCI format size associated with the waveform that requires the larger number of bits among the number of bits associated with the candidate waveforms. In 640, the UE 116 determines a waveform for the PUSCH transmission from the value of the waveform flag field of the DCI format. In 650, the UE 116 determines a number of bits that provide actual information for a field of the DCI format based on the determined waveform. 620 to 650 are also applicable when, in 610, the UE 116 is provided transformPrecoder in pusch-Config with value ‘enabled’. Additionally, or alternatively, the indication of the waveform by the DCI format can be applicable only when a value of transformPrecoder in pusch-Config is ‘disabled’, or only when a value of transformPrecoder in pusch-Config is ‘enabled’, and the indication can be an indication to switch to a different waveform. Alternatively, in 630 the UE 116 can assume a certain size of the DCI format as provided for transformPrecoder in pusch-Config.

For a PUSCH scheduled by random access response (RAR) UL grant, or for a PUSCH scheduled by fallbackRAR UL grant, or for a PUSCH scheduled by DCI format 0_0 with cyclic redundancy check (CRC) scrambled by temporary cell-radio network temporary identifier (TC-RNTI), the UE 116 shall consider the transform precoding either ‘enabled’ or ‘disabled’ according to an indication by msg3-transformPrecoder. For a MsgA PUSCH, the UE 116 shall consider the transform precoding either ‘enabled’ or ‘disabled’ according to an indication by msgA-TransformPrecoder. If msgA-TransformPrecoder is not provided, the UE 116 shall consider the transform precoding either ‘enabled’ or ‘disabled’ according to an indication by msg3-transformPrecoder. For PUSCH transmission scheduled by a DCI format with CRC scrambled by CS-RNTI with new data indicator (NDI)=1, C-RNTI, or modulation and coding scheme (MCS)-C-RNTI or semi-persistent (SP)-CSI-RNTI, the UE 116 shall consider the transform precoding for the PUSCH transmission to be either enabled or disabled according to an indication by msg3-transformPrecoder if the DCI format is DCI format 1_0; otherwise, the UE 116 shall consider the transform precoding for the PUSCH transmission to be either enabled or disabled according to an indication by transformPrecoder in pusch-Config, if provided and according to an indication by msg3-transformPrecoder if transformPrecoder in pusch-Config is not provided. For PUSCH transmission with a configured grant (CG-PUSCH), if the UE 116 is provided transformPrecoder in configuredGrantConfig, the UE 116 shall consider the transform precoding for the CG-PUSCH transmission to be either enabled or disabled according to an indication by transformPrecoder; otherwise, the UE 116 shall consider the transform precoding for the CG-PUSCH transmission to be either enabled or disabled according to an indication by msg3-transformPrecoder.

A DCI format scheduling a PUSCH transmission can include a 1-bit field to indicate the waveform for the PUSCH transmission. For example, a waveform flag of 1 bit can be included in DCI format 0_1 or DCI format 0_2 with CRC scrambled by temporary cell-radio network temporary identifier (C-RNTI) or configured scheduling (CS)-RNTI or SP-CSI-RNTI or MCS-C-RNTI. For example, a waveform flag bit value of ‘0’ or ‘1’ can respectively indicate use of the CP-OFDM waveform or of the DFT-S-OFDM waveform for the PUSCH transmission, or vice versa. The waveform indication provided by the DCI format scheduling the PUSCH transmission supersedes the indication provided by transformPrecoder in pusch-Config, if configured, or by msg3-transformPrecoder.

It is possible that a 1-bit waveform flag in a DCI format that schedules a PUSCH transmission or activates a configured grant Type 2 PUSCH transmission can indicate additional information besides DFT-S-OFDM or CP-OFDM. In one example, the bit value of “0” can indicate DFT-S-OFDM with rank 1 for the PUSCH transmission and the bit value of “1” can indicate CP-OFDM (with a rank value provided by a higher layer parameter) for the PUSCH transmission, or vice versa. The rank 1 value of DFT-S-OFDM provided by the indication supersedes a higher layer configured value for the rank, if provided. In another example, the indication of DFT-S-OFDM in the DCI format is for a value of the rank larger than 1, for example rank 2. In yet another example, the bit value of “0” can indicate DFT-S-OFDM with rank 1 for the PUSCH transmission and the bit value of “1” can indicate DFT-S-OFDM with rank 2 for the PUSCH transmission, or vice versa. In yet another example, more than 1 bit is used to indicate the waveform and the rank: with 2 bits it can be indicated DFT-S-OFDM with rank 1, DFT-S-OFDM with rank 2, CP-OFDM with rank 1 and CP-OFDM with rank 2, or 1 bit indicates DFT-S-OFDM or CP-OFDM and another bit indicates the rank among two rank values that can be both larger than 1. The rank values can be configured by higher layers and the bits in the DCI indicate one of the configured values. It is also possible that the waveform types can be configured by higher layers and the bits in the DCI indicate one of the configured types.

A waveform flag can be used to determine the sizes of other fields in a DCI format scheduling a PUSCH transmission that change depending on whether DFT-S-OFDM or CP-OFDM waveform is used for the PUSCH transmission. Similar to when the information of the waveform is provided only by a higher layer parameter and the UE 116 determines a size of a field in a DCI format depending on the waveform, the UE 116 can determine the size of the field in the DCI format from the value of the waveform flag field in the DCI format. Thus, if the waveform flag is not present in the DCI format, the UE 116 determines the size of a field in the DCI format that depends on the waveform based on the higher layer parameter indicating the waveform, and if the waveform flag is present in the DCI format, the UE 116 assumes that a size of a field in the DCI format that depends on the waveform is the largest between the size when the waveform is DFT-S-OFDM and the size when the waveform is CP-OFDM wherein, depending on the indicated waveform for the PUSCH transmission, all bits, or all bits except one or more most significant bits (MSBs), or all bits except one or more least significant bits (LSBs), of the DCI field are used to determine the information conveyed by that field.

Thus, for a DCI format that can be used for scheduling a PUSCH transmission or for activating a configured grant Type 2 PUSCH transmission with candidate waveforms DFT-S-OFDM or CP-OFDM, a size of the DCI format needs to be same when, otherwise, a total number of sizes of DCI formats used for scheduling on the scheduled cell would exceed a predetermined maximum number of sizes of DCI formats that can be predetermined in the specifications of the system operation or indicated by the UE 116 as a capability. The UE 116 expects the same size for the DCI format when the waveform indication is DFT-S-OFDM and when it is CP-OFDM. For example, a size of a scheduling DCI format 0_1 or 0_2 for scheduling a PUSCH transmission or of an activation DCI for a configured grant Type 2 PUSCH transmission semi-persistently scheduled by an UL grant should be same regardless of whether the DCI format indicates DFT-S-OFDM or CP-OFDM. Depending on whether the UE 116 is scheduled or configured to transmit PUSCH with DFT-S-OFDM or CP-OFDM, some fields of the DCI format change size and the DCI size alignment needs to be done according to the larger size of the DCI format as also illustrated in 630 of FIG. 6. The DCI size alignment can be done by aligning the size of each of the fields of the DCI format and adding padding bits to each field of the DCI format with the smaller size, or adding padding bits at the end of the DCI format with smaller size until the size is same as the larger size.

When a UE is configured with scheduling on more than one uplink carriers, for example with UL carrier aggregation (CA) or dual connectivity (DC), or with supplementary UL (SUL), for a same DCI format that can be used for scheduling on more than one carrier and can provide a waveform indication, a size of the DCI format needs to be same otherwise a total number of sizes of DCI formats would exceed a predetermined maximum number of sizes of DCI formats that can be predetermined in the specifications of the system operation or indicated by the UE 116 as a capability. The UE 116 expects the same size for the DCI format when the waveform indication is any of the candidate waveforms. Thus, DCI size alignment for different candidate waveforms needs to be done so that a same size of the DCI format for scheduling on more than one carrier can be used. In a first example the indicated waveform in the DCI format is same for all scheduled or activated uplink transmissions on the multiple uplink carriers or on SUL and non-SUL carriers. In a second example the indicated waveform in the DCI format is different for at least one of the scheduled or activated uplink transmissions on the multiple uplink carriers, or the indicated waveform on SUL is different than the one indicated for non-SUL carriers.

When a UE is configured with a DCI format that schedules multiple uplink transmissions on the same carrier and provides a waveform indication, wherein the DCI format can indicate a same waveform for the multiple scheduled uplink transmissions or indicate a different waveform for one or more of the multiple scheduled uplink transmissions, a size of the DCI format needs to be same for different candidate waveform indications. Thus, DCI size alignment for different candidate waveforms is needed.

When a UE is configured with scheduling on a scheduled cell, such as the primary cell (PCell), with multiple scheduling cells, such as the PCell and a secondary cell (SCell) for a UE, for a same DCI format that can be used for scheduling the UE 116 on the scheduled cell from the multiple scheduling cells and for providing a waveform indication, a size of the DCI format needs to be same on the multiple scheduling cells for different candidate waveform indications. Thus, DCI size alignment for different candidate waveforms is needed.

Throughout this disclosure, an indication of a waveform for a PUSCH transmission, with or without repetitions, and carried in a field of a DCI format that schedules (or activates) the PUSCH transmission is referred as dynamic waveform indication, or dynamic waveform switching (DSW) information.

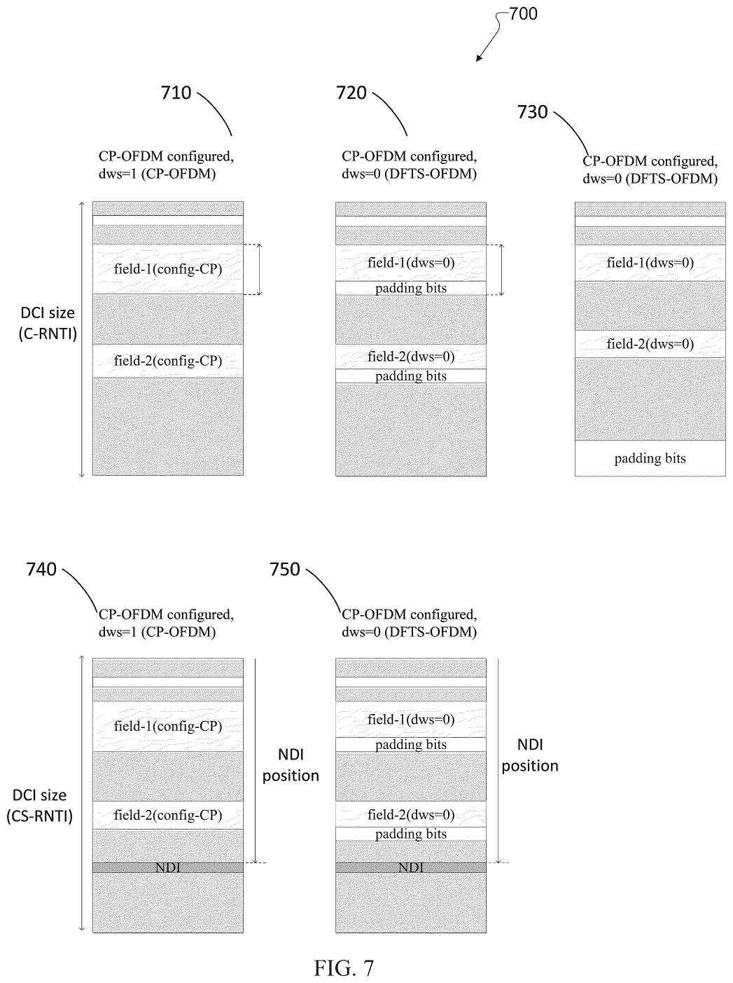

FIG. 7 illustrates diagrams 700 of example CP-OFDM configurations according to embodiments of the present disclosure. For example, the UE 116 of FIG. 3 can adapt its reception(s) according to diagrams 700 of example CP-OFDM configurations. This example is for illustration only and other embodiments can be used without departing from the scope of the present disclosure.

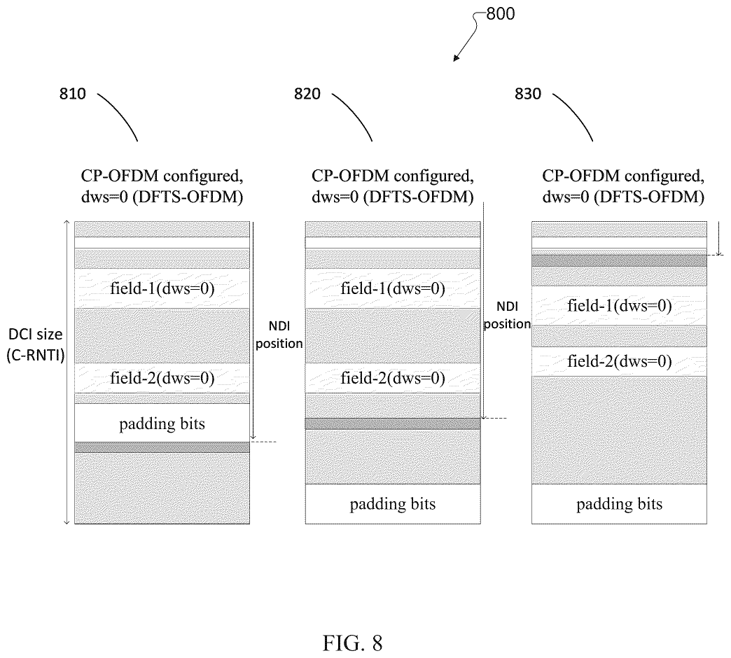

FIG. 8 illustrates diagrams 800 of example CP-OFDM configurations according to embodiments of the present disclosure. For example, the UE 115 of FIG. 1 can adapt its reception(s) according to diagrams 800 of example CP-OFDM configurations. This example is for illustration only and other embodiments can be used without departing from the scope of the present disclosure.

When a DCI format includes a field that indicates a waveform, a DCI size alignment needs to be done between sizes of the DCI format for the different waveforms that can be indicated and for the different scrambling codes. For example, DCI size alignment needs to be done for the cases when the DCI format indicates CP-OFDM or DFT-S-OFDM and is scrambled by C-RNTI or CS-RNTI. For the DCI format scrambled by CS-RNTI, it needs to be taken into account that the UE 116 does not expect that the bit width of a field in DCI format 0_1 with CRC scrambled by CS-RNTI is larger than corresponding bit width of same field in DCI format 0_1 with CRC scrambled by C-RNTI for the same serving cell. If the bit width of a field in the DCI format 0_1 with CRC scrambled by CS-RNTI is not equal to that of the corresponding field in the DCI format 0_1 with CRC scrambled by C-RNTI for the same serving cell, a number of most significant bits with value set to ‘0’ are inserted to the field in DCI format 0_1 with CRC scrambled by CS-RNTI until the bit width equals that of the corresponding field in the DCI format 0_1 with CRC scrambled by C-RNTI for the same serving cell.

When a UE is configured by a higher layer parameter with CP-OFDM, fields of the DCI format that have bit widths depending on the waveform can have bit widths corresponding to the configured CP-OFDM waveform. the bit widths are the largest among the bit widths of such fields for CP-OFDM and DFT-S-OFDM.
If the waveform indication indicates CP-OFDM, the UE 116 expects that the bit widths of fields with bit widths depending on the waveform are according to the configured waveform for a DCI format scrambled by C-RNTI, as illustrated in 710 of FIG. 7, and for a DCI format scrambled by CS-RNTI, as illustrated in 740 of FIG. 7, and all bits in such fields provide a corresponding information. For the DCI format scrambled by CS-RNTI, the UE 116 expects the NDI bit in a position determined by assuming that bit widths of fields depending on the waveform and preceding the NDI bit are according to the configured waveform.
If the waveform indication indicates DFT-S-OFDM, the UE 116 expects that the bit widths of fields with bit widths depending on the waveform are according to the configured waveform for a DCI format scrambled by C-RNTI, as illustrated in 720 of FIG. 7, and for a DCI format scrambled by CS-RNTI, as illustrated in 740 of FIG. 7. In such fields, a number of bits corresponding to the bit width of the field according to the indicated waveform provides a corresponding information and the remaining bits (either the MSBs or the LSBs of that field) are padding bits. For the DCI scrambled by CS-RNTI, the UE 116 expects the NDI bit in a position determined by assuming that bit widths of fields depending on the waveform and preceding the NDI bit are according to the configured waveform.
Alternatively to 720 of FIG. 7, when the waveform indication indicates DFT-S-OFDM, the UE 116 can expect that bit widths of fields with bit widths depending on the waveform are according to the indicated waveform for a DCI format scrambled by C-RNTI, but a number of padding bits are added at the end of the DCI format so that the total size of the DCI format is the same independently of the indicated waveform, as illustrated in 730 of FIG. 7.
If the waveform indicates DFT-S-OFDM, the UE 116 expects that the bit widths of fields with bit widths depending on the waveform are according to the configured waveform for a DCI format scrambled by CS-RNTI, as illustrated in 750 of FIG. 7. In such fields, a number of bits corresponding to the bit width of the field according to the indicated waveform provides a corresponding information and the remaining bits (either the MSBs or the LSBs of that field) are padding bits. For the DCI scrambled by CS-RNTI, the UE 116 expects the NDI bit in a position determined by assuming that bit widths of fields depending on the waveform and preceding the NDI bit are according to the configured waveform.
Alternatively to 740 of FIG. 7, when the waveform indication indicates DFT-S-OFDM, the UE 116 can expect that bit widths of fields with bit widths depending on the waveform are according to the indicated waveform for a DCI format scrambled by CS-RNTI, and that padding bits are added in the DCI format according to one of the following example procedures.
   In a first example, illustrated in 810 of FIG. 8, a number of padding bits are added before the field of the NDI bit, wherein the number of padding bits is given by the difference of the number of bits needed for the configured CP-OFDM waveform and the number of bits needed for the indicated DFT-S-OFDM waveform for fields with bit widths depending on the waveform and preceding the NDI field.
   In a second example, illustrated in 820 of FIG. 8, a number of padding bits are added at the end of the DCI format. The UE 116 expects the NDI bit in a position determined by assuming bit widths of fields depending on the waveform and preceding the NDI bit are according to the indicated waveform.
   In a third example, illustrated in 830 of FIG. 8, a number of padding bits are added at the end of the DCI format and the UE 116 expects the NDI bit in a position of the DCI format before fields with bit widths depending on the waveform. For example, the NDI bit can be immediately before or after the waveform indication bit, and the NDI field and the waveform indication field, or vice versa, can be the second and third field of the DCI format, or the third and fourth field, respectively.

When a UE is configured by a higher layer parameter with DFT-S-OFDM, fields of the DCI format that have bit widths depending on the waveform can have bit widths corresponding to the configured waveform or larger.

If the indicated waveform is DFT-S-OFDM:
In a first example (no padding bits), the UE 116 expects that the bit widths of fields with bit widths depending on the waveform are according to the configured waveform for a DCI format scrambled by C-RNTI and for a DCI format scrambled by CS-RNTI if the indicated waveform is the same. No padding bits are added. The UE 116 also expects that the NDI bit in the DCI format scrambled by CS-RNTI is in a position determined by assuming that bit widths of fields depending on the waveform and preceding the NDI bit, if any, are according to the configured waveform. The UE 116 parses the waveform indication bit and acquires the information of the waveform and then determines the bit widths of field with bit widths depending on the waveform.
In a second example (padding bits added at the end of the DCI format), the UE 116 expects that the bit widths of fields with bit widths depending on the waveform are according to the configured waveform for a DCI format scrambled by C-RNTI and for a DCI format scrambled by CS-RNTI and padding bits are added at the end of the DCI format in order to have a same size independently of the configured or indicated waveform. The UE 116 also expects that the NDI bit in the DCI format scrambled by CS-RNTI is in a position determined by assuming that bit widths of fields depending on the waveform and preceding the NDI bit, if any, are according to the configured waveform. The UE 116 parses the waveform indication bit and acquires the information of the waveform and then determines the bit widths of the field in the DCI.
In a third example (padding bits added per field), the UE 116 expects that the bit widths of fields with bit widths depending on the waveform are according to the waveform with the largest bit width for that field independently of the configured or indicated waveform. The UE 116 parses the waveform indication bit and acquires the information of the waveform and then determines the bits carrying a corresponding information and the padding bits.

If the indicated waveform is CP-OFDM, fields of the DCI format with bit widths depending on the waveform can have bit widths corresponding to the indicated waveform. The UE 116 parses the waveform indication bit and acquires the information of the waveform and then determines the bits carrying a corresponding information and the padding bits of a DCI field if needed.

Thus, the position of the field carrying the waveform indication in the DCI format needs to be before fields with bit widths that depend on the waveform so that the UE 116 can determine the waveform first and then determine the bit widths of other fields subsequent to the waveform indication field. The UE 116 can determine the bit widths of fields preceding the NDI field after determining the indicated waveform, or alternatively the NDI field can be positioned before other fields with bit widths that depend on the waveform.

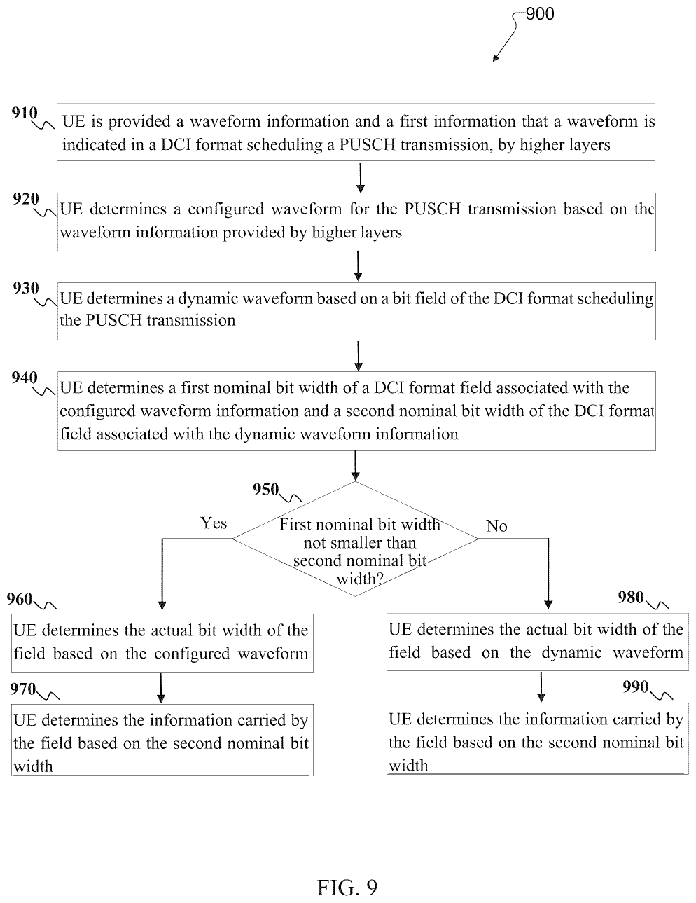

FIG. 9 illustrates a flowchart of an example UE procedure 900 for determining information according to embodiments of the present disclosure. For example, procedure 900 for determining information can be performed by any of the UEs 111-116 of FIG. 1. This example is for illustration only and other embodiments can be used without departing from the scope of the present disclosure.

The procedure begins in 910, a UE is provided a waveform information and a first information that a waveform is indicated in a DCI format scheduling a PUSCH transmission, by higher layers. In 920, the UE 116 determines a configured waveform for the PUSCH transmission based on the waveform information provided by higher layers. In 930, the UE 116 determines a dynamic waveform based on a bit field of the DCI format scheduling the PUSCH transmission. In 940, the UE 116 determines a first nominal bit width of a DCI format field associated with the configured waveform information and a second nominal bit width of the DCI format field associated with the dynamic waveform information. In 950, when the first nominal bit width is not smaller than the second nominal bit width, in 960, the UE 116 determines the actual bit width of the field based on the configured waveform and, in 970, determines the information carried by the field based on the second nominal bit width 870. Otherwise, in 980, the UE 116 determines the actual bit width of the field based on the dynamic waveform and, in 990, determines the information carried by the field based on the second nominal bit width.

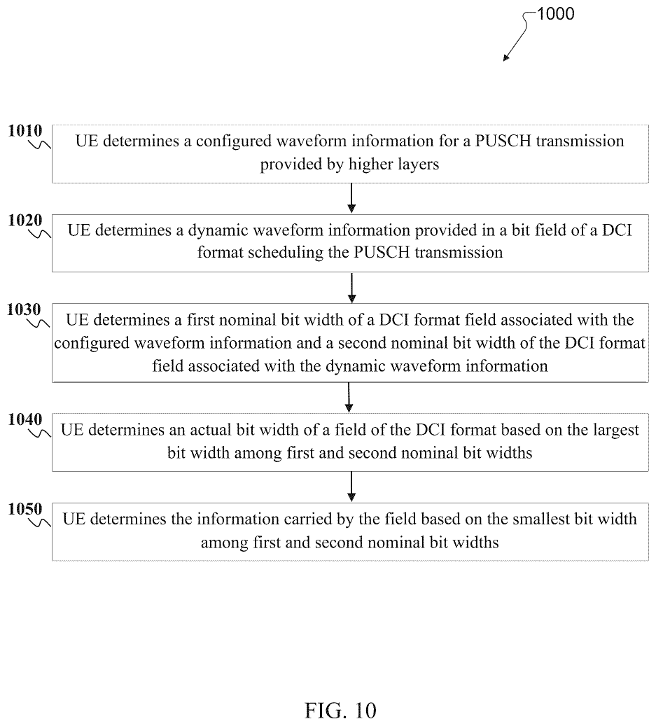

FIG. 10 illustrates a flowchart of an example UE procedure 1000 for determining information according to embodiments of the present disclosure. For example, UE procedure 1000 for determining information can be performed by the UE 116 of FIG. 3. This example is for illustration only and other embodiments can be used without departing from the scope of the present disclosure.

The procedure begins in 1010, a UE determines a configured waveform information for a PUSCH transmission provided by higher layers. In 1020, the UE 116 determines a dynamic waveform information provided in a bit field of a DCI format scheduling the PUSCH transmission. In 1030, the UE 116 determines a first nominal bit width of a DCI format field associated with the configured waveform information and a second nominal bit width of the DCI format field associated with the dynamic waveform information. In 1040, the UE 116 determines an actual bit width of a field of the DCI format based on the largest bit width among first and second nominal bit widths. In 1050, the UE 116 determines the information carried by the field based on the smallest bit width among first and second nominal bit widths.

For a PUSCH scheduled by a DCI format 0_1 or 0_2 with CRC scrambled by C-RNTI, the DCI size alignment can be done by adding padding bits per DCI format or per field when needed. If padding bits are added per DCI format, a number of bits with value set to ‘0’ are added at the end of the DCI format until the size of the DCI format equals the size of the DCI format with the largest bit widths (among the bit widths required for DFT-S-OFDM and CP-OFDM) for fields with bit width depending on the waveform. If padding bits are added per field, a number of most significant bits with value set to ‘0’ are inserted to a field in DCI format until the bit width equals that of the field when the waveform is the one that requires the largest number of bits for that field. The UE 116 assumes that the bit width of the field is equal to the largest bit width among the bit widths for DFT-S-OFDM and CP-OFDM, which may or may not be the same bit width corresponding to the configured waveform. The waveform indication can be included in a DCI format scrambled by CS-RNTI with NDI=1, and the size alignment between the DCI format scrambled by CS-RNTI and the DCI format scrambled by C-RNTI is done according to the procedure in clause 7.3.1.1.2 of REF[2].

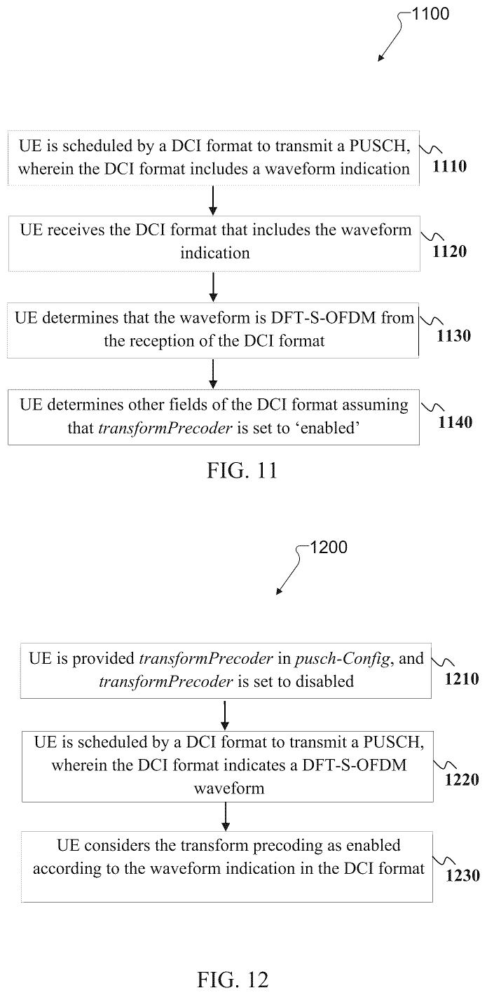

FIG. 11 illustrates a flowchart of an example UE procedure 1100 for determining information according to embodiments of the present disclosure. For example, procedure 1100 for determining information can be performed by the UE 115 of FIG. 1. This example is for illustration only and other embodiments can be used without departing from the scope of the present disclosure.

The procedure begins in 1110, a UE is scheduled by a DCI format to transmit a PUSCH, wherein the DCI format includes a waveform indication. In 1120, the UE 116 receives the DCI format that includes the waveform indication. In 1130, the UE 116 determines that the waveform is DFT-S-OFDM from the reception of the DCI format. In 1140, the UE 116 determines other fields of the DCI format assuming that transformPrecoder is set to ‘enabled’. 1110 to 1120 equally apply for a PUSCH transmission is with repetitions or for a TB processing over multiple slots. 1120 to 1140 equally apply when in 1110 the DCI format activates a configured grant Type 2 PUSCH transmission, wherein the PUSCH transmission can be with or without repetitions.

In one embodiment, the waveform indication field of a DCI format scrambled by C-RNTI or CS-RNTI precedes fields with bit widths depending on the waveform and that the waveform indication field precedes the NDI field in a DCI format scrambled by CS-RNTI. If the waveform field is present in the DCI format with CS-RNTI, the value of the NDI bit would be 1 (NDI=0 is an error case).
If CP-OFDM is configured, and DFT-S-OFDM is indicated in the DCI format:
a) Padding per DCI format:
   For C-RNTI: UE reads the waveform indication and assumes that the sizes of fields in the DCI format with C-RNTI are according to the indicated waveform (smaller size) and that padding bits are added at the end of the DCI format.
   For CS-RNTI: UE reads the waveform indication then reads the NDI bit positioned after fields, if any, depending on the waveform and with sizes according to the indicated waveform.
b) Padding per field:
   For C-RNTI: UE reads the waveform indication and assumes that the sizes of the fields in the DCI format with C-RNTI are according to the configured waveform (larger size) and that padding bits are added for the MSB(s) of such field of the DCI format.
   For CS-RNTI: UE reads the waveform indication, then reads the NDI bit positioned after fields, if any, depending on the waveform and with sizes according to the configured waveform.
If DFT-S-OFDM is configured, and CP-OFDM is indicated in the DCI format
   For C-RNTI: UE reads the waveform indication and assumes that the sizes of the fields in the DCI format with C-RNTI are according to the indicated waveform (larger size), no padding is needed.
   For CS-RNTI: UE reads the waveform indication, then reads the NDI bit positioned after fields, if any, depending on the waveform and with sizes according to the indicated waveform.

Thus, both a) padding per DCI format and b) padding per field for DCI size alignment of a DCI format 0_1 or 0_2 scrambled by C-RNTI are feasible. DCI size alignment for CS-RNTI is done as per existing procedure.

If the presence of the waveform indication in the DCI format scrambled by CS-RNTI depends on whether the NDI field is 1 (waveform indication field is present) or 0 (waveform indication field is not present), then the NDI field can be before the field that includes the waveform indication.

It is possible that when the UE 116 is configured with an indication of a waveform for a PUSCH transmission in a DCI format scheduling the PUSCH transmission, the sizes of the fields of the DCI format that depend on the waveform are same as the largest sizes among the possible sizes associated with the candidate waveforms. For example, if DFT-S-OFDM and CP-OFDM are the two waveforms, when the UE 116 is configured with the indication of the waveform in the DCI format, the sizes of the fields of the DCI that depend on the waveform have sizes corresponding to CP-OFDM. For the DCI alignment, padding bits are added per field when the indicated waveform in the DCI format is DFT-S-OFDM. No padding bits are added when the indicated waveform in the DCI format is CP-OFDM. Thus, when the UE 116 is configured with the DCI format that includes the waveform indication, the size of a field of the DCI format that depends on the waveform is set to the largest size among the candidate sizes corresponding to the candidate waveform, and padding bits are added, if necessary, in the field until the set size.

For a PUSCH transmission scheduled by a DCI format, in a first example, when the DCI format indicates a waveform, the UE 116 transmits the PUSCH using the waveform indicated by the DCI format. If the DCI format scheduling the PUSCH does not include a waveform indication field, the UE 116 transmit the PUSCH using the waveform indicated by transformPrecoder in pusch-Config, if configured, or by msg3-transformPrecoder.

In a second example, a higher layer parameter enables the waveform indication by the DCI format. When the waveform indication provided by the DCI format is enabled by the higher layer parameter, the UE 116 transmits the PUSCH using the waveform indicated by the DCI format; otherwise, the UE 116 transmits the PUSCH using the waveform indicated by transformPrecoder in pusch-Config, if configured, or by msg3-transformPrecoder.

In a third example, when transformPrecoder in pusch-Config is set to ‘disabled’, if configured, or when msg3-transformPrecoder is set to ‘disabled’, and then the UE 116 is configured for PUSCH transmissions with CP-OFDM and the UE 116 detects the DCI format scheduling the PUSCH transmission and indicating the waveform. The UE 116 transmits the PUSCH using the waveform according to the indication by the DCI format.

In a fourth example, when transformPrecoder in pusch-Config is set to ‘enabled’, if configured, or when msg3-transformPrecoder is set to ‘enabled’, and then the UE 116 is configured for PUSCH transmissions with DFT-S-OFDM, and the UE 116 detects the DCI format scheduling the PUSCH transmission and indicating the waveform, the UE 116 transmits the PUSCH using the DFT-S-OFDM waveform and ignores the waveform indication in the DCI format.

In a fifth example, when a UE detects a DCI format scheduling a PUSCH transmission and indicating a waveform, and a waveform indication bit is set to “1”, the UE 116 switches the waveform for PUSCH transmission as follows: if transformPrecoder in pusch-Config, if configured, and/or if msg3-transformPrecoder is set to ‘enabled’, the UE 116 transmits the PUSCH using CP-OFDM; otherwise, if transformPrecoder in pusch-Config, if configured, and/or if msg3-transformPrecoder is set to ‘disabled’, the UE 116 transmits the PUSCH using the DFT-S-OFDM. If the waveform indication bit in the DCI format is set to “0”, the UE 116 uses the waveform indicated by transformPrecoder in pusch-Config, if configured, and/or if msg3-transformPrecoder for the PUSCH transmission. Alternatively, when the waveform indication bit is set to “0”, the UE 116 switches the waveform for the PUSCH transmission with respect to the waveform indicated by higher layers. When the waveform indication bit is set to “1”, the UE 116 does not switch the waveform for the PUSCH transmission with respect to the waveform indicated by higher layers.

In a sixth example, an indication of a waveform in a DCI format can be valid not only for a PUSCH transmission scheduled by the DCI format that includes a waveform indication field but also for other transmissions by the UE 116 during a time interval of a configured duration and starting from the PUSCH transmission scheduled by the DCI format. For example, the duration in number of consecutive slots can be provided by higher layers and the starting slot of the time interval is the first slot of the scheduled PUSCH transmission. Or if the PUSCH is with repetitions over a number of slots or is with TB processing over multiple slots, the starting slot is the slot of the first repetition or the first slot of the multiple slots for TB processing over multiple slots. During the time interval the UE 116 uses the indicated waveform and, if the UE 116 receives a new waveform indication during the time interval, the UE 116 may ignore the waveform indication, or use the newly indicated waveform and restart the time interval according to the newly indicated waveform.

For a PUSCH transmission with a configured grant (CG-PUSCH), in a first example the UE 116 uses the waveform indicated by transformPrecoder in configuredGrantConfig, if configured, or by msg3-transformPrecoder.

For a CG-PUSCH transmission and in a second example:
for a configured grant Type 1 PUSCH transmission upon the reception of configuredGrantConfig including rrc-ConfiguredUplinkGrant without detection of an UL grant, the UE 116 uses the waveform indicated by transformPrecoder in configuredGrantConfig, if configured, or by msg3-transformPrecoder; and/or
for a configured grant Type 2 PUSCH transmission that is activated by an UL grant according to clause 10.2 of REF[3] after the reception of configuredGrantConfig not including rrc-ConfiguredUplinkGrant, the UE 116 uses the waveform indicated by transformPrecoder in configuredGrantConfig, if configured, or by msg3-transformPrecoder, if the activation DCI does not include a waveform indication; otherwise, the UE 116 uses the waveform indicated in the activation DCI, wherein the waveform indication can indicate either CP-OFDM or DFT-S-OFDM, or can indicate to switch waveform with respect to the waveform provided by transformPrecoder in configuredGrantConfig, if configured, or by msg3-transformPrecoder.

An indication of a waveform in a DCI format that schedules a PUSCH transmission or activates a configured grant Type 2 PUSCH transmission can be for DFT-S-OFDM or CP-OFDM and overrides the information provided by transformPrecoder in pusch-Config or configuredGrantConfig or msg3-transformPrecoder or msgA-TransformPrecoder, wherein transformPrecoder can be set to either ‘enabled’ or ‘disabled’. Other parameter settings used in the procedures for the PUSCH transmission can be affected by the waveform indication in the DCI format.

In a first example, if transformPrecoder is set to ‘disabled’ and the waveform indication in a DCI format that schedules a PUSCH transmission or activates a configured grant Type 2 PUSCH transmission indicates DFT-S-OFDM, the UE 116 shall consider that transform precoding is enabled for the PUSCH transmission.

In a second example, if transformPrecoder is enabled and the waveform indication in a DCI format that schedules a PUSCH transmission or activates a configured grant Type 2 PUSCH transmission indicates CP-OFDM, the UE 116 shall consider that the transform precoding is disabled for the PUSCH transmission.

In a third example, if transformPrecoder is set to ‘disabled’ and the waveform indication in a DCI format that schedules a PUSCH transmission or activates a configured grant Type 2 PUSCH transmission indicates CP-OFDM, the UE 116 shall consider the transform precoding as disabled for the PUSCH transmission. In this example the waveform indication is same as the configured waveform, and the higher layer parameter settings apply.

Thus, when the waveform indication in a DCI format that schedules a PUSCH transmission or activates a configured grant Type 2 PUSCH transmission indicates a different waveform than a waveform configured by higher layers, the UE 116 shall consider transform precoding to be enabled or disabled according to the waveform indication in the DCI format scheduling the PUSCH transmission or activating the configured grant Type 2 PUSCH transmission.

When the UE 116 considers transform precoding to be enabled or disabled according to the waveform indication in the DCI format scheduling the PUSCH transmission or activating the configured grant Type 2 PUSCH transmission, limitations for the PUSCH transmission based on whether transform precoding is enabled or disabled, described in clause 6.1 of REF[4] apply.

For resource allocation in frequency domain, similar to the descriptions in clause 6.1.2.2 of REF[4], uplink resource allocation scheme type 0 is supported for PUSCH only when transform precoding is disabled or the indicated waveform is CP-OFDM. Uplink resource allocation scheme type 1 and type 2 are supported for PUSCH for both cases when transform precoding is enabled or disabled, or the indicated waveform is DFT-S-OFDM or CP-OFDM. For uplink resource allocation type 2, if the indicated waveform is DFT-S-OFDM, then the UE 116 transmits PUSCH on the lowest-indexed M_{RB}^{PUSCH} physical resource blocks (PRBs) amongst the PRBs indicated by the frequency domain resource assignment information. M_{RB}^{PUSCH} is the largest integer not greater than the number of RBs indicated by the frequency domain resource assignment information that fulfils the conditions in clause 6.3.1.4 of REF[1].

FIG. 12 illustrates a flowchart of an example UE procedure 1200 for considering a transform precoding according to embodiments of the present disclosure. For example, procedure 1200 for determining information can be performed by any of the UEs 111-116 of FIG. 1. This example is for illustration only and other embodiments can be used without departing from the scope of the present disclosure.

The procedure begins in 1210, a UE is provided transformPrecoder in pusch-Config, and transformPrecoder is set to ‘disabled’. In 1220, the UE 116 is scheduled by a DCI format to transmit a PUSCH, wherein the DCI format indicates a DFT-S-OFDM waveform. In 1230, the UE 116 considers the transform precoding as enabled according to the waveform indication in the DCI format.

For a PUSCH transmission corresponding to a Type 1 configured grant or a Type 2 configured grant and activated by a DCI format 0_0 or 0_1, the parameters applied for the PUSCH transmission are provided by configuredGrantConfig except for dataScramblingIdentityPUSCH, txConfig, codebookSubset, maxRank, scaling of UCI-OnPUSCH, that are provided by pusch-Config. For the PUSCH transmission corresponding to a Type 2 configured grant activated by DCI format 0_2, the parameters applied for the transmission are provided by configuredGrantConfig except for dataScramblingIdentityPUSCH, txConfig, codebookSubsetDCI-0-2, maxRankDCI-0-2, scaling of UCI-OnPUSCH, resource AllocationType1GramularityDCI-0-2 provided by pusch-Config.

When the UE 116 is configured with transform precoding as disabled and receives an indication for DFT-S-OFDM waveform in a DCI format scheduling a PUSCH transmission, if a higher layer parameter providing the rank for the PUSCH transmission is set to a value larger than 1, the UE 116 considers that for the PUSCH transmission with DFT-S-OFDM, the rank is 1.

When the UE 116 is configured with transform precoding as enabled and receives an indication for a CP-OFDM waveform in a DCI format scheduling a PUSCH transmission, if the higher layer parameter providing the rank is set to a value of 1, the UE 116 considers that for the PUSCH transmission with CP-OFDM, the rank is 1.

For a PUSCH transmission scheduled by RAR UL grant, or for a PUSCH transmission scheduled by fallbackRAR UL grant, or for a PUSCH transmission scheduled by DCI format 0_0 with CRC scrambled by TC-RNTI, the UE 116 shall consider the transform precoding to be either ‘enabled’ or ‘disabled’ according to the higher layer configured parameter msg3-transformPrecoder.

For a MsgA PUSCH transmission, the UE 116 shall consider the transform precoding to be either ‘enabled’ or ‘disabled’ according to msgA-TransformPrecoder. If msgA-TransformPrecoder is not provided, the UE 116 shall consider the transform precoding to be either ‘enabled’ or ‘disabled’ according to msg3-transformPrecoder.

For a PUSCH transmission scheduled by a PDCCH providing a DCI format with CRC scrambled by CS-RNTI with NDI=1, C-RNTI, or MCS-C-RNTI or SP-CSI-RNTI:
If the DCI format is DCI format 0_0, the UE 116 shall consider the transform precoding for the PUSCH transmission to be either enabled or disabled according to msg3-transformPrecoder and the indication of the waveform in the DCI format.
If the DCI format is not DCI format 0_0:
   If the UE 116 is provided transformPrecoder in pusch-Config, the UE 116 shall consider the transform precoding for the PUSCH transmission to either ‘enabled’ or ‘disabled’ according to transformPrecoder.
   If the UE 116 is not provided transformPrecoder in pusch-Config, the UE 116 shall consider the transform precoding for the PUSCH transmission to be either enabled or disabled according to msg3-transformPrecoder.

For PUSCH transmission with a configured grant:
If the UE 116 is provided transformPrecoder in configuredGrantConfig, the UE 116 shall consider the transform precoding for the PUSCH transmission to be either enabled or disabled according to transformPrecoder.
If the UE 116 is not provided transformPrecoder in configuredGrantConfig, the UE 116 shall consider the transform precoding for the PUSCH transmission to be either enabled or disabled according to msg3-transformPrecoder

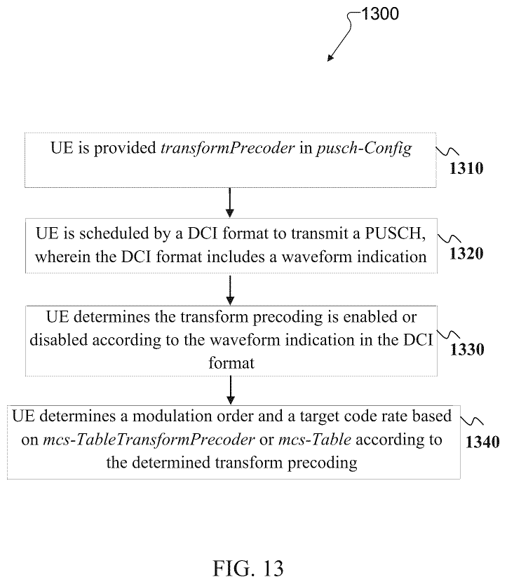

FIG. 13 illustrates a flowchart of an example UE procedure 1300 for determining a modulation order and a target code rate according to embodiments of the present disclosure. For example, procedure 1300 for determining a modulation order and a target code rate can be performed by the UE 116 of FIG. 3. This example is for illustration only and other embodiments can be used without departing from the scope of the present disclosure.

The procedure begins in 1310, a UE is provided transformPrecoder in pusch-Config. In 1320, the UE 116 is scheduled by a DCI format to transmit a PUSCH, wherein the DCI format includes a waveform indication field. In 1330, the UE 116 determines that transform precoding is enabled or disabled according to a value of the waveform indication field in the DCI format. In 1340, the UE 116 determines a modulation order and a target code rate based on mcs-TableTransformPrecoder or mes-Table according to the determined transform precoding. A similar procedure as described by steps 1310 to 1340 applies for configured grant PUSCH transmission.

A UE considers that transform precoding is enabled or disabled according to an indication by a waveform field in a DCI format scheduling a PUSCH transmission. The UE 116 also considers that other higher layer parameters are configured according to the assumed transform precoding. For example, when the waveform indication is DFT-S-OFDM, transformPrecoder is assumed to be enabled, and the corresponding mcs-TableTransformPrecoder is used for modulation order and target code rate determination in REF[4] clause 6.1.4.1. When the waveform indication is CP-OFDM, transformPrecoder is assumed disabled and the corresponding mcs-Table is used for modulation order and target code rate determination in REF[4] clause 6.1.4.1.

Procedures in REF[4] clause 6.1.4.1 for the determination of the modulation order and code rate that apply when transform precoding provided by a higher layer parameter is disabled also apply when the waveform is indicated in a DCI format that schedules a PUSCH transmission or activates a configured grant Type 2 PUSCH transmission and the indicated waveform is CP-OFDM. Thus, the condition for applying the procedures described in REF[4] clause 6.1.4.1 shall also consider the waveform indication conditioned on the following: “if transform precoding is disabled for the PUSCH transmission according to REF[4] clause 6.1.3, or if a waveform indication in a DCI format is CP-OFDM, if present”.

Procedures in REF[4] clause 6.1.4.1 for the determination of the modulation order and code rate that apply when transform precoding provided by a higher layer parameter is enabled also apply for the case that the waveform is indicated in a DCI format that schedules a PUSCH transmission or activates a configured grant Type 2 PUSCH transmission and the indicated waveform is DFT-S-OFDM. Thus, the condition for applying such procedures described in REF[4] clause 6.1.4.1 shall also consider the waveform indication by the DCI format condition on the following: “if transform precoding is enabled for the PUSCH transmission according to REF[4] clause 6.1.3, or if a waveform indication is DFT-S-OFDM, if present”.

Procedures in REF[4] clause 6.1.4.2 for the determination of the transport block size that apply when transform precoding provided by a higher layer parameter is enabled or disabled also apply for the case that the waveform is indicated in a DCI format that schedules a PUSCH transmission or activates a configured grant Type 2 PUSCH transmission and the indicated waveform is DFT-S-OFDM or CP-OFDM, respectively.

Procedures in REF[4] clause 6.2.2 for UE DM-RS transmission that apply when transform precoding provided by a higher layer parameter is enabled or disabled also apply for the case that the waveform is indicated in a DCI format that schedules a PUSCH transmission or activates a configured grant Type 2 PUSCH transmission and the indicated waveform is DFT-S-OFDM or CP-OFDM, respectively.

Procedures in REF[4] clause 6.2.3 for UE PT-RS transmission that apply when transform precoding provided by a higher layer parameter is enabled or disabled also apply for the case that the waveform is indicated in a DCI format that schedules a PUSCH transmission or activates a configured grant Type 2 PUSCH transmission and the indicated waveform is DFT-S-OFDM or CP-OFDM, respectively.

Procedures in REF[4] clause 6.3 for UE PUSCH frequency hopping for PUSCH repetition Type A, or for TB processing over multiple slots, or for PUSCH repetition Type B, that apply when transform precoding provided by a higher layer parameter is enabled or disabled, also apply for the case that the waveform is indicated in a DCI format that schedules a PUSCH transmission or activates a configured grant Type 2 PUSCH transmission and the indicated waveform is DFT-S-OFDM or CP-OFDM, respectively.

Whether a DCI format scheduling a PUSCH transmission includes an indication of a waveform can be subject to a UE capability and/or to a configuration that enables an indication of a waveform in a DCI format. The waveform can also be indicated for a PUSCH transmission of PUSCH repetition Type A scheduled by DCI format 0_0, or 0_1, or 0_2, PUSCH repetition Type A with a configured grant, PUSCH repetition Type B, and TB processing over multiple slots.

To dynamically indicate a waveform for a Msg3 PUSCH transmission during initial access to a UE, a gNB needs to identify that the UE 116 has the capability of receiving an indication of the waveform for Msg3 PUSCH transmission prior to the UE 116 establishing a dedicated RRC connection.

A gNB can indicate a partition of PRACH resources according to a UE capability of receiving a waveform indication for a Msg3 PUSCH transmission. The partition of PRACH resources can be associated with more than one features or capabilities of the UE 116. For example, the partition of PRACH resources can be associated with support of receiving the waveform indication for Msg3 PUSCH transmission and with support and/or a request of transmission with repetitions of the Msg3 PUSCH. The UE 116 can select a PRACH resource from that partition of PRACH resources based on its support of receiving the waveform indication for Msg3 PUSCH transmission and support and/or request of transmission with repetitions of the Msg3 PUSCH. It is possible that a first partition is for PRACH resources associated with support of the waveform indication for Msg3 PUSCH transmission feature and a second partition is for PRACH resources associated with no support of the feature. The UE 116 can select a PRACH resource from the first or second partition of PRACH resources based on its capability of supporting or not the feature. Alternatively, the UE 116 can select the partition of PRACH resources based on an RSRP measurement, for example based on a synchronization signal/physical broadcast channel (SS/PBCH) block reception, and an RSRP threshold indicated in a SIB or having a fixed value, wherein the RSRP threshold can be specific to receiving the waveform indication for Msg3 PUSCH transmission or can be a threshold associated with more than one feature. In one example, a gNB can configure a same RSRP threshold, rsrp-ThresholdMsg3, for transmission of Msg3 PUSCH with repetitions and for reception of the waveform indication for Msg3 PUSCH transmission. In another example, the gNB 102 can indicate a separate RSRP threshold, rsrp-ThresholdMsg3waveform, for reception of the waveform indication for Msg3 PUSCH transmission. In a third example, the gNB 102 assumes that a UE capable of transmitting Msg3 PUSCH with repetitions according to the rsrp-ThresholdMsg3, is also capable of reception of the waveform indication for Msg3 PUSCH transmission.

When a gNB identifies that a UE supports a dynamic waveform indication for PUSCH scheduled by RAR UL grant and when the UE 116 transmits PUSCH scheduled by RAR UL grant, the waveform indication can be provided in a field of the RAR UL grant. When the UE 116 transmits PUSCH scheduled by DCI format 0_0 with CRC scrambled by the TC-RNTI, the waveform indication can be provided in a field of the DCI format 0_0 with CRC scrambled by the TC-RNTI.

In a first example, the waveform indication is provided by one bit of the MCS field of the RAR UL grant. When the UE 116 transmits the Msg3 PUSCH with repetitions and receives the waveform indication, 3 bits of the MCS field, the 3 MSBs of the MCS field or the 3 LSBs of the MCS field of which 2 bits are for Msg3 PUSCH repetitions and 1 bit is for waveform indication, can be used to indicate the number of repetitions for Msg3 PUSCH transmission and the waveform.

In a second example, the waveform indication is provided by one bit of the MCS field of the DCI format 0_0 with CRC scrambled by the TC-RNTI. When the UE 116 transmits the Msg3 PUSCH with repetitions and receives the waveform indication, 4 bits of the MCS field, the 4 MSBs of the MCS field or the 4 LSBs of the MCS field of which 3 bits are for Msg3 PUSCH repetitions and 1 bit is for waveform indication, can be used to indicate the number of repetitions for Msg3 PUSCH transmission and the waveform.

It is also possible that the waveform indication is implicitly provided by the configuration for Msg3 PUSCH repetitions and the codepoints used to determine the MCS index I_{MCS} according to Table 6.1.4.1-3 or Table 6.1.4.1-4 in REF[4], without using a separate bit of the MCS field to indicate the waveform.

In a third example, when the UE 116 transmits PUSCH scheduled by RAR UL grant and the 2 LSBs of the MCS information field of the RAR UL grant provide a codepoint to determine the MCS index I_{MCS} according to Table 6.1.4.1-3 in REF[4] (illustrated herein), the waveform can be implicitly indicated using one or more of the following options.
If mcs-Msg3-Repetitions is not configured, the UE 116 determines the waveform for the PUSCH transmission according to the higher layer configured parameter msg3-transformPrecoder.
If mcs-Msg3-Repetitions is configured, the UE 116 determines the waveform for the PUSCH transmission as DFT-S-OFDM.
If mcs-Msg3-Repetitions is configured and codepoint is 00, the UE 116 determines the waveform for the PUSCH transmission:
   according to the higher layer configured parameter msg3-transformPrecoder; or
   as CP-OFDM.
If mcs-Msg3-Repetitions is configured, and codepoint is one of {01,10,11}, the UE 116 determines the waveform for the PUSCH transmission as DFT-S-OFDM.

TABLE 1
(Table 6.1.4.1-3 in REF[4]: MCS index I_{MCS} as a function
of 2 LSBs of MCS information field in RAR UL grant)

| mcs-Msg3-Repetitions is | | mcs-Msg3-Repetitions is not | |
|---|---|---|---|
| configured | | configured | |
| Codepoint | I_{MCS} | Codepoint | I_{MCS} |
| 00 | First value of mcs- | 00 | 0 |
| | Msg3-Repetitions | | |
| 01 | Second value of mcs- | 01 | 1 |
| | Msg3-Repetitions | | |
| 10 | Third value of mcs- | 10 | 2 |
| | Msg3-Repetitions | | |
| 11 | Fourth value of mcs- | 11 | 3 |
| | Msg3-Repetitions | | |

In a fourth example, when the UE 116 transmits PUSCH scheduled by DCI format 0_0 with CRC scrambled by the TC-RNTI, and the 3 LSBs of the MCS information field of the DCI format 0_0 with CRC scrambled by the TC-RNTI provide a codepoint to determine the MCS index I_{MCS} according to Table 6.1.4.1-4 in REF[4] (illustrated herein), the waveform can be implicitly indicated using one or more of the following options.
If mcs-Msg3-Repetitions is not configured, the UE 116 determines the waveform for the PUSCH transmission according to the higher layer configured parameter msg3-transformPrecoder.
If mcs-Msg3-Repetitions is configured, the UE 116 determines the waveform for the PUSCH transmission as DFT-S-OFDM.
If mcs-Msg3-Repetitions is configured and codepoint is 000, the UE 116 determines the waveform for the PUSCH transmission:
   according to the higher layer configured parameter msg3-transformPrecoder, or
   as CP-OFDM.
If mcs-Msg3-Repetitions is configured and codepoint is one of {001,010,011,101,110,111}, the UE 116 determines the waveform for the PUSCH transmission as DFT-S-OFDM.
If mcs-Msg3-Repetitions is configured and codepoint is one of {000,001,010,011}, the UE 116 determines the waveform for the PUSCH transmission as CP-OFDM; else, if codepoint is one of {100,101,110,111} the UE 116 determines the waveform for the PUSCH transmission as DFT-S-OFDM.

TABLE 2
(Table 6.1.4.1-4 in REF[4]: MCS index I_{MCS} as
a function of 3 LSBs of MCS information field in DCI format
0_0 with CRC scrambled by the TC-RNTI)

| mcs-Msg3-Repetitions is | | mcs-Msg3-Repetitions is not | |
|---|---|---|---|
| configured | | configured | |
| Codepoint | I_{MCS} | Codepoint | I_{MCS} |
| 000 | First value of mcs- | 000 | 0 |
| | Msg3-Repetitions | | |
| 001 | Second value of mcs- | 001 | 1 |
| | Msg3-Repetitions | | |
| 010 | Third value of mcs- | 010 | 2 |
| | Msg3-Repetitions | | |
| 011 | Fourth value of mcs- | 011 | 3 |
| | Msg3-Repetitions | | |
| 100 | Fifth value of mcs- | 100 | 4 |
| | Msg3-Repetitions | | |
| 101 | Sixth value of mcs- | 101 | 5 |
| | Msg3-Repetitions | | |
| 110 | Seventh value of mcs- | 110 | 6 |
| | Msg3-Repetitions | | |
| 111 | Eighth value of mcs- | 111 | 7 |
| | Msg3-Repetitions | | |

In a fifth example, 1 bit of a transmit power control (TPC) command field in a DCI format can be used to indicate the waveform.

In a sixth example, 1 bit of a redundancy version (RV) field in a DCI format can be used to indicate the waveform.

Therefore, prior to establishing an RRC connection, a waveform indication for the PUSCH transmission can be indicated by a field in a RAR UL grant or in a DCI format scheduling the PUSCH transmission by using one or more bits of existing field in the DCI format such as the MCS field, the TPC command field, the RV field, or the frequency domain resource assignment (FDRA) field. A bit from the aforementioned fields can be used to indicate an interpretation for the remaining bits as being a common one associated with the functionality of those fields or as indicating a number of repetitions. The bits can be defined in the specification of the system operation. The waveform can also be implicitly indicated by an association of a candidate waveform with the higher layer parameter mcs-Msg3-Repetitions and codepoints to determine the MCS index.

When a gNB identifies that a UE supports a dynamic waveform indication for PUSCH scheduled by RAR UL grant and the UE 116 does not receive a waveform indication in a DCI format scheduling the PUSCH transmission, for the Msg3 PUSCH the UE 116 shall consider the transform precoding either ‘enabled’ or ‘disabled’ according to the higher layer configured parameter msg3-transformPrecoder.

In a first example, when the higher layer configured parameter msg3-transformPrecoder is set to ‘enabled’ and a PUSCH scheduled by RAR UL grant is with repetitions, the UE 116 receives a waveform indication in a DCI format 0_0 with CRC scrambled by TC-RNTI that schedules a retransmission of the PUSCH with repetitions. In a second example, when the higher layer configured parameter msg3-transformPrecoder is set to ‘disabled’ and a PUSCH scheduled by RAR UL grant is without repetitions, the UE 116 receives a waveform indication in a DCI format 0_0 with CRC scrambled by TC-RNTI that schedules a retransmission of the PUSCH with repetitions.

Descriptions in this disclosure for Msg3 PUSCH transmission during initial access also apply for Msg3 PUSCH transmission in connected mode, wherein the PRACH transmission can be triggered by higher layers at the UE 116 or by network indication via a PDCCH order. In one example, the UE 116 attempts to detect a DCI format 1_0 with CRC scrambled by the corresponding random access (RA)-RNTI in response to a PRACH transmission initiated by the PDCCH order that triggers a contention-free random access procedure and the DCI format 1_0 can include a 1-bit field to indicate the waveform among two candidate waveform, e.g. DFT-S-OFDM and CP-OFDM. In another example, the DCI format providing the PDCCH order can include the waveform indication in a 1-bit field. When the 1-bit field is not included in the DCI format 1_0 with CRC scrambled by the corresponding RA-RNTI or in the DCI format providing the PDCCH order, and/or a higher layer parameter that enables/disables the waveform indication is configured and set to “disable”, the UE 116 shall consider the transform precoding either ‘enabled’ or ‘disabled’ according to the higher layer configured parameter msg3-transformPrecoder and assume the corresponding waveform. The higher layer parameter that configures the waveform indication in a DCI format scheduling a PUSCH transmission as either ‘enabled’ or ‘disabled’ can apply to the DCI format scrambled by C-RNTI.

When a DCI format includes a field that indicates a waveform or equivalently indicates whether the transform precoder is enabled or disabled, a DCI size alignment needs to be done because some fields of the DCI format have sizes that depends on the waveform a size of the DCI format needs to be same otherwise a total number of sizes of DCI formats would exceed a predetermined maximum number of sizes of DCI formats that can be predetermined in the specifications of the system operation or indicated by the UE 116 as a capability. In addition, as previously described, the field that indicates the waveform can have different sizes. For example, 1-bit can be used if the field indicates a waveform from two candidate waveforms, or 2-bits can be used if the field indicates a waveform and a rank, or indicates a combination from four possible combinations of waveform and rank, or indicates a waveform for each of two uplink transmissions when the DCI schedules two uplink transmissions on the same carrier or schedules two uplink transmissions on two different uplink carriers, or schedules two uplink transmissions on two different TRPs. The field that indicates the waveform can be an n-bit field, wherein n is an integer value larger than 0 and the size n is subject to a configuration. For a PUSCH transmission, if the DCI with the scheduling grant was received with DCI format 0_1 or 0_2 or 0_3 and if the UE 116 is configured with a higher layer parameter dynamic TransformPrecoderIndicationDCI-0-1 in pusch-Config for DCI format 0_1 or dynamicTransformPrecoderIndicationDCI-0-2 in pusch-Config for DCI format 0_2 or dynamic TransformPrecoderIndicationDCI-0-3 in pusch-Config for DCI format 0_3 and the higher layer parameter is set to enabled, the UE 116 shall, for this PUSCH transmission, consider the transform precoding either enabled or disabled according to the waveform indicator field, or equivalently of the transform precoder indicator field, in the DCI with the scheduling grant. Higher layer parameters dynamic TransformPrecoderIndicationDCI-0-1 and dynamic TransformPrecoderIndicationDCI-0-2 indicate whether the field that indicates a waveform or equivalently indicates whether the transform precoder is enabled or disabled, is present in the respective DCI format. For DCI format 0_3, the higher layer parameter dynamic TransformPrecoderIndicationDCI-0-3, in addition to indicating the presence of the field that indicates a waveform or equivalently indicates whether the transform precoder is enabled or disabled, also indicates the size of the field.

In one example, dynamic TransformPrecoderIndicationDCI-0-3 indicates only the presence of the field in the DCI format, similar to dynamic TransformPrecoderIndicationDCI-0-1 and dynamic TransformPrecoderIndicationDCI-0-2 for respective DCI formats. The size of the field that indicates a waveform, or equivalently indicates whether the transform precoder is enabled or disabled in the DCI format 0_3, is 1-bit and the indication of the 1-bit field applies to all scheduled PUSCH transmissions on a same carrier or different carriers.

In one example, dynamic TransformPrecoderIndicationDCI-0-3 indicates only the presence of the field in the DCI format, similar to dynamic TransformPrecoderIndicationDCI-0-1 and dynamic TransformPrecoderIndicationDCI-0-2 for respective DCI formats. The size of the field that indicates a waveform, or equivalently indicates whether the transform precoder is enabled or disabled in the DCI format 0_3, is 1-bit and the indication of the 1-bit field applies to the one or more scheduled PUSCH transmissions on a specific cell or a specific carrier.

In one example, dynamic TransformPrecoderIndicationDCI-0-3 indicates only the presence of the field in the DCI format, similar to dynamic TransformPrecoderIndicationDCI-0-1 and dynamic TransformPrecoderIndicationDCI-0-2 for respective DCI formats. The size of the field that indicates a waveform, or equivalently indicates whether the transform precoder is enabled or disabled in the DCI format 0_3, is equal to the number of scheduled PUSCH transmissions on a same carrier or different carriers, and each bit of the field is associated with a corresponding PUSCH transmission from the scheduled PUSCH transmissions by DCI format 0_3.

Whether the dynamic waveform indication field is one or more bits can be subject to a configuration, and the size of the DCI format 0_3 is determined as described TS 38.212 v.18.0.0 using the configured size for the dynamic waveform indication.

Whether the dynamic waveform indication field is one or more bits can depend on the size of another field in the DCI format 0_3 that can be located before or after the dynamic waveform indication field. If the dynamic waveform indication field is located before the other field, the size of the DCI format 0_3 is determined as described in TS 38.212 v.18.0.0 assuming a first size for the dynamic waveform indication field, wherein the first size can be a configured value for the dynamic waveform indication field or can be a value associated with the largest size of the other field or can be a largest value associated with the indication in the other field. It is possible that the first size is set to 1 and the indication for the waveform applies to the multiple uplink transmissions scheduled by the DCI format 0_3. If the dynamic waveform indication field is located after the other field, the size of the DCI format 0_3 is determined as described in TS 38.212 v.18.0.0, with the size of the dynamic waveform field determined based on the indication of the other field.

A dynamic waveform indication for an uplink transmission can be provided by a DCI format that schedules the uplink transmission in the UL bandwidth part (BWP) associated with the DL BWP where the DCI format is received, wherein the UL BWP can be the only UL BWP associated with the DL BWP or can be one of the more than one UL BWPs associated with the DL BWP.

A dynamic waveform indication for an uplink transmission can be provided by a DCI format that schedules the uplink transmission in a frequency region of a BWP.

In one example, a UE receives a DCI format that schedules an uplink transmission and includes a dynamic waveform indication in a DL BWP paired with an UL BWP or in a portion of the DL BWP paired with the UL BWP, wherein the uplink transmission is scheduled in a portion of the UL BWP.

In one example, a UE operates in TDD mode and is provided a TDD UL-DL configuration. A slot can be a downlink slot with all downlink symbols, or an uplink slots with all uplink symbols, or a slot with downlink, and/or flexible symbols, and/or uplink symbols. In one example, a slot can be also configured with sub-bands of a BWP, wherein each symbol of the slot can be either a DL symbol in the DL sub-band or an UL symbol in the UL sub-band. Within the BWP, there can be at least one sub-band for UL and one sub-band for DL, or one sub-band for UL and two sub-bands for the UL, and the UL sub-band occupies the middle region and the DL sub-band occupy the edge regions of the BWP. The UE 116 can receive a DCI format that schedules an uplink transmission and includes a dynamic waveform indication in a DL sub-band within the BWP or in the whole BWP. The uplink transmission can be scheduled in the UL sub-band of the BWP. In one example, a slot can also be configured with more than one uplink sub-band and a single DCI format can schedule uplink transmissions in the multiple UL sub-bands or multiple DCI formats can schedule multiple uplink transmissions in the multiple UL sub-bands. The single DCI format that schedules the multiple uplink transmissions can include a dynamic waveform indication field of one or multiple bits, wherein a 1-bit field indicates the waveform for the scheduled uplink transmissions on the multiple UL sub-bands or a multiple-bits field indicates the waveform for the respective scheduled uplink transmissions on the multiple UL sub-bands. In one example, the UL sub-band of the carrier does not overlap with the DL sub-band, and a PDCCH reception that includes the DCI format that schedules the uplink transmission and includes the dynamic waveform indication, and the uplink transmission, occur in non-overlapping time intervals.

When a UE is configured for Multiple Transmit/Receive Point (multi-TRP) operation, the UE 116 can be scheduled by a serving cell from two or more TRPs in order to provide better PDSCH coverage, reliability and/or data rates. There are two different operation modes for multi-TRP: single-DCI and multi-DCI. For both modes, control of uplink and downlink operation can be done by physical layer and MAC layer, within the configuration provided by the RRC layer. In single-DCI mode, UE is scheduled by the same DCI for all TRPs and in multi-DCI mode, UE is scheduled by independent DCIs from each TRP. The UE 116 can be configured with multi-TRP operation with a serving cell TRP and another TRP with a different physical cell ID (PCI) from the PCI of the serving cell, or with a serving cell TRP and a number of non-serving cell TRPs with different PCIs from the PCI of the serving cell.

In single-DCI mode, UE is scheduled by a single DCI format for all TRPs. In one example, the DCI format includes a 1-bit dynamic waveform indication field for the scheduled uplink transmissions for the multiple TRPs. In one example, the DCI format includes a multi-bit dynamic waveform indication field for the scheduled uplink transmissions for the multiple TRPs. For single DCI-mode, whether the DCI format includes the dynamic waveform indication field is subject to a configuration.

In multi-DCI mode, UE is scheduled by multiple DCI formats from each TRP and the DCI formats can include a 1-bit dynamic waveform indication field for the scheduled uplink transmission for the corresponding TRP, subject to a configuration or a UE capability. In one example for two TRPs, it is possible that a first DCI format that schedules an uplink transmission on a first TRP includes a waveform indication field, and a second DCI format that schedules an uplink transmission on a second TRP does not include a waveform indication field. It is also possible that the first and second DCI formats include the waveform indication field, or none of the DCI formats includes the waveform indication field, and this can be subject to a configuration. In one example, for a UE configured with multi-TRP operation with a serving cell TRP and a non-serving cell TRP with a PCI different from the serving cell PCI, only the DCI format scheduling the uplink transmission on the serving cell TRP can include the waveform indication field.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive:
first information by higher layers indicating whether transform precoding is enabled or disabled,
second information by higher layers indicating a presence of a transform precoder indication (TPI) field in a downlink control information (DCI) format,
third information by higher layers for a configuration related to a resource allocation associated with transmissions of physical uplink shared channels (PUSCHs) with transform precoding disabled, and
a physical downlink control channel (PDCCH) providing the DCI format that schedules a transmission of a PUSCH, wherein, when the second information indicates that the TPI field is present, the DCI format includes the TPI field; and
a processor operably coupled to the transceiver, the processor configured to determine:
whether the transform precoding is enabled or disabled based on the TPI field,
that the configuration is used when transform precoding is disabled, and
that the configuration is not used when transform precoding is enabled,
wherein the transceiver is further configured to transmit the PUSCH:
with transform precoding and without the configuration, when transform precoding is enabled, or
without transform precoding and with the configuration, when transform precoding is disabled.

2. The UE of claim 1, wherein:
the TPI field comprises one bit,
a bit value of 0 indicates transform precoding enabled, and
a bit value of 1 indicates transform precoding disabled.

3. The UE of claim 1, wherein:
the DCI format schedules the transmission of the PUSCH on a first carrier and a transmission of one other PUSCH on a second carrier,
the TPI field includes two or more bits, and
a first bit is associated with the transmission of the PUSCH on the first carrier and a second bit is associated with the transmission of the one other PUSCH on the second carrier.

4. The UE of claim 1, wherein the transceiver is further configured to:
receive the PDCCH in a first sub-band of a carrier, and
transmit the PUSCH in a second sub-band of the carrier that does not overlap with the first sub-band, wherein the PDCCH reception and the PUSCH transmission occur in non-overlapping time intervals.

5. The UE of claim 1, wherein:
the DCI format is a DCI format 1_0 with a cyclic redundancy check (CRC) scrambled by a cell-radio network temporary identifier (C-RNTI), and
the transmission of the PUSCH is with repetitions.

6. The UE of claim 1, wherein:
a first field of the DCI format includes a number of bits,
the number of bits depends on the first information,
the first field is positioned after the TPI field,
the second information indicates that the TPI field of the DCI format is present, and
the first field of the DCI format comprises a corresponding number of bits associated with transform precoding set to disabled regardless of whether the TPI field indicates that transform precoding is enabled or disabled.

7. The UE of claim 1, wherein:
a first field of the DCI format includes a number of bits,
the number of bits depends on the first information,
the first field is positioned after the TPI field,
the second information does not indicate the TPI field of the DCI format is present, and
the first field of the DCI format comprises one of:
a first number of bits when the first information indicates transform precoding is enabled, or
a second number of bits when the first information indicates transform precoding is disabled.

8. A base station (BS) comprising:
a transceiver configured to transmit:
first information by higher layers indicating whether transform precoding is enabled or disabled,
second information by higher layers indicating a presence of a transform precoder indication (TPI) field in a downlink control information (DCI) format,
third information by higher layers for a configuration related to a resource allocation associated with receptions of physical uplink shared channels (PUSCHs) with transform precoding disabled, and
a physical downlink control channel (PDCCH) providing the DCI format that schedules a reception of a PUSCH, wherein, when the second information indicates that the TPI field is present, the DCI format includes the TPI field; and
a processor operably coupled to the transceiver, the processor configured to determine:
whether the transform precoding is enabled or disabled based on the TPI field,
that the configuration is used when transform precoding is disabled, and
that the configuration is not used when transform precoding is enabled;
wherein the transceiver is further configured to receive the PUSCH:
with transform precoding and without the configuration, when transform precoding is enabled, or
without transform precoding and with the configuration, when transform precoding is disabled.

9. The BS of claim 8, wherein:
the TPI field comprises one bit,
a bit value of 0 indicates transform precoding enabled, and
a bit value of 1 indicates transform precoding disabled.

10. The BS of claim 8, wherein:
the DCI format schedules the reception of the PUSCH on a first carrier and a reception of one other PUSCH on a second carrier,
the TPI field includes two or more bits, and
a first bit is associated with the reception of the PUSCH on the first carrier and a second bit is associated with the reception of the one other PUSCH on the second carrier.

11. The BS of claim 8, wherein the transceiver is further configured to:
transmit the PDCCH in a first sub-band of a carrier, and
receive the PUSCH in a second sub-band of the carrier that does not overlap with the first sub-band, wherein the PDCCH transmission and the PUSCH reception occur in non-overlapping time intervals.

12. The BS of claim 8, wherein:
a first field of the DCI format includes a number of bits,
the number of bits depends on the first information,
the first field is positioned after the TPI field,
the second information indicates that the TPI field of the DCI format is present, and
the first field of the DCI format comprises a corresponding number of bits associated with transform precoding set to disabled regardless of whether the TPI field indicates that transform precoding is enabled or disabled.

13. The BS of claim 8, wherein:
a first field of the DCI format includes a number of bits,
the number of bits depends on the first information,
the first field is positioned after the TPI field,
the second information does not indicate the TPI field of the DCI format is present, and
the first field of the DCI format comprises one of:
a first number of bits when the first information indicates transform precoding is enabled, or
a second number of bits when the first information indicates transform precoding is disabled.

14. A method comprising:
receiving:
first information by higher layers indicating whether transform precoding is enabled or disabled,
second information by higher layers indicating a presence of a transform precoder indication (TPI) field in a downlink control information (DCI) format,
third information by higher layers for a configuration related to a resource allocation associated with transmissions of physical uplink shared channels (PUSCHs) with transform precoding disabled, and
a physical downlink control channel (PDCCH) providing the DCI format that schedules a transmission of a PUSCH, wherein, when the second information indicates that the TPI field is present the DCI format includes the TPI field;
determining:
whether the transform precoding is enabled or disabled based on the TPI field,
that the configuration is used when transform precoding is disabled, and
that the configuration is not used when transform precoding is enabled; and
transmitting the PUSCH:
with transform precoding and without the configuration, when transform precoding is enabled, or
without transform precoding and with the configuration, when transform precoding is disabled.

15. The method of claim 14, wherein:
the TPI field comprises one bit,
a bit value of 0 indicates transform precoding enabled, and
a bit value of 1 indicates transform precoding disabled.

16. The method of claim 14, wherein:
the DCI format schedules the transmission of the PUSCH on a first carrier and a transmission of one other PUSCH on a second carrier, and
the TPI field includes two or more bits, wherein a first bit is associated with the transmission of the PUSCH on the first carrier and a second bit is associated with the transmission of the one other PUSCH on the second carrier.

17. The method of claim 14, wherein:
receiving the PDCCH further comprises receiving the PDCCH in a first sub-band of a carrier,
transmitting the PUSCH further comprises transmitting the PUSCH in a second sub-band of the carrier that does not overlap with the first sub-band, and
the PDCCH reception and the PUSCH transmission occur in non-overlapping time intervals.

18. The method of claim 14, wherein:
the DCI format is a DCI format 1_0 with a cyclic redundancy check (CRC) scrambled by a cell-radio network temporary identifier (C-RNTI), and
the transmission of the PUSCH is with repetitions.

19. The method of claim 14, wherein:
a first field of the DCI format includes a number of bits,
the number of bits depends on the first information,
the first field is positioned after the TPI field,
the second information indicates that the TPI field of the DCI format is present, and
the first field of the DCI format comprises a corresponding number of bits associated with transform precoding set to disabled regardless of whether the TPI field indicates that transform precoding is enabled or disabled.

20. The method of claim 14, wherein:
a first field of the DCI format includes a number of bits,
the number of bits depends on the first information,
the first field is positioned after the TPI field,
the second information does not indicate the TPI field of the DCI format is present, and
the first field of the DCI format comprises one of:
a first number of bits when the first information indicates transform precoding is enabled, or
a second number of bits when the first information indicates transform precoding is disabled.
